(19) United States
(12) Patent Application Publication
(10) Pub. No.: US 2015/0207455 A1
(43) Pub. Date: Jul. 23, 2015

(54) Dense-Array Concentrator Photovoltaic System Utilising Non-Imaging Dish Concentrator And Array Of Crossed Compound Parabolic Concentrators

(71) Applicant: Universiti Tunku Abdul Rahman, Petaling Jaya (MY)

(72) Inventors: Kok Keong Chong, Kuala Lumpur (MY); Tiong Keat Yew, Jitra (MY); Ming Hui Tan, Penampang (MY)

(21) Appl. No.: 14/462,891

(22) Filed: Aug. 19, 2014

(30) Foreign Application Priority Data
Jan. 23, 2014 (MY) PI2014000210

(51) Int. Cl. H02S 40/22

(52) U.S. Cl. CPC H02S 40/22

(57) ABSTRACT

Disclosed is a solar concentrator assembly (100) having a non-imaging dish concentrator (NIDC) (110) which consists of a plurality of flat facets mirrors (160) arranged in such a way that all the mirror images are superimposed to form reasonably uniform irradiance and either square or rectangular pattern of concentrated sunlight at a common receiver without sunlight blocking and shadowing on each other. The geometry of the NIDC (110) is determined using a special computational method. A plurality of secondary concentrators (120) formed by an array of crossed compound parabolic concentrators is used to further focus the concentrated sunlight by the NIDC (110) onto active area of solar cells (230) of the concentrator photovoltaic receiver (170). The invention maximizes the absorption of concentrated sunlight for the electric power generation system.

### CROSS-REFERENCE TO RELATED APPLICATIONS

This application claims the benefit under 35 U.S.C. §119(a) of Malaysian Application No. PI 2014000210, filed on Jan. 23, 2014, and is hereby incorporated by reference in its entirety for all purposes.

### FIELD OF INVENTION

The present invention relates to the field of solar electrical power generation system. More particularly, the present invention relates to dense-array concentrator photovoltaic (CPV) systems utilizing non-imaging dish concentrator and array of crossed compound parabolic concentrators (CCPC) to improve the overall energy conversion efficiency.

### BACKGROUND OF THE INVENTION

Developing countries across the globe struggle in deriving or generating the basic necessities of life for themselves. Among the other necessities, energy supply such as electricity still remains one of the major requirements in the economies of developing nations which is unattained. Over the years, people have largely relied on fossil fuels to meet their energy demands. However, the indiscriminate uses of these non-renewable sources of energy have posed a threat of their depletion in the near future and hence the search for alternative sources of energy generation is sought. Owing to the need of the hour, tapping of renewable sources of energy such as solar energy to meet the growing demands has significantly increased.

Solar energy is available in plenty and it can be utilized by converting it to different energy forms such as thermal and electrical energy. Thus, the solar energy can be stored in different forms for use according to the need of the consumer. However, conventional flat plate solar energy converters are less efficient and having higher cost compared to fossil fuel. Alternatively, a more advanced energy conversion systems such as solar concentrating systems are proposed with the aim to improve the conversion efficiency of solar energy converter.

Photovoltaic cells are in use to convert solar energy into electrical energy. These cells can operate on the sunlight falling on it directly. However, since the photovoltaic cells are relatively expensive, it is judicious to concentrate the solar energy with the aid of concentrators which can then be targeted to the photovoltaic cells. A number of individual photovoltaic cells comprise a photovoltaic receiver that converts solar energy to electrical energy.

Various types of reflective and refractive solar concentrators have been devised for concentrating photovoltaic systems such as the parabolic dish, line-focus concentrator, Fresnel lens and point focus lens. With the different types of concentrators in use, the receiver of the concentrator can be configured in either individual cell receiver or dense-array of solar cells receiver dependent on the area of the focused sunlight. For individual cell configuration, the area of focused sunlight that is incident on the solar cell is about the same as the area of the single solar cell active area. For dense-array configuration, the area of the focused sunlight is much larger than the active area of one solar cell, therefore an array of solar cells that is connected in series or parallel to form a receiver with larger area is used to convert the sunlight into electricity. The solar cells need to be assembled closely to each other to avoid blank gap without active area of solar cell. In the assembly of dense-array module, packing factor is defined as percentage of active area of solar cells over the total module area and is useful in defining the efficiency of the solar electricity generation system. Practically, it is impossible to achieve 100% of packing factor due to the presence of physical connections between solar cells and physical constrain of the substrate of solar cells. Constrains mentioned above will create some blank gap without active area in the assembled module and the focused sunlight that drop at the blank gap will become losses to the system because it cannot be converted to electricity.

In existing dense-array CPV system such as parabolic dish and central receiver system, the secondary optics is not widely applied or fully explored for improving the overall performance of CPV receiver especially in reducing the energy losses due to lower packing factor of solar cells. The most common application of secondary optics is only limited to single cell CPV module coupled to Fresnel lens as the primary concentrator especially for improving uniformity of concentrated sunlight.

To reduce the losses mentioned above in dense array configuration system, an improved system would be needed to increase the sunlight falling on the active area of the solar cell. The needed system would introduce more improved concentrators by integrating an array of secondary concentrators that would guide the sunlight that drop outside the solar cell active area onto the active area and thereby increasing the electrical power output.

### SUMMARY OF THE INVENTION

The present invention is an improved and efficient solar concentrator assembly of a solar electrical power generation system. The present invention utilizes a non-imaging dish concentrator integrated with an array of crossed compound parabolic concentrators (CCPC) in the application of dense-array concentrator photovoltaic (CPV) system.

The non-imaging dish concentrator (NIDC) consists of a plurality of flat facet mirrors arranged in such a way that all the mirror images are superimposed at the common receiver without sunlight blocking and shadowing on each other. The arc-shape or a new geometry of the NIDC according to the present invention is generated with a special computational algorithm, which is designed to determine the relative height and tilted angles of each flat facet so that all the facet images are well superimposed on the common receiver without sunlight blocking and shadowing among the facet mirrors. A plurality of secondary concentrators or secondary optics, which is an array of CCPC in the form of lenses, is used to direct the concentrated sunlight by the NIDC falling onto active area of CPV cells only. The secondary optics acts as optical funnel with larger area on the entrance surface and smaller area in exit surface, which allow more space for the inter-connection among the CPV cells located at exit surface in either series or parallel as to minimize current mismatch in the circuit without affecting the overall performance of CPV system.

The invention can reduce the losses in dense-array CPV cells caused by the difficulty to achieve high packing factor due to the unavoidable spacing needed for cell inter-connection and thus maximize the absorption of concentrated sunlight for the electrical power generation system. With the secondary optics, it also allows more flexibility of inter-connection among the cells for minimizing the current mismatch loss. In addition, the array of secondary concentrators can increase the acceptance angle of dense-array CPV system and hence allow higher tolerance to pointing error of sun-tracking system. Furthermore, the proposed primary NIDC can project a reasonably uniform irradiance and square or rectangular pattern of concentrated sunlight onto the secondary optics.

Other objects and advantages of the embodiments herein will become readily apparent from the following detailed description taken in conjunction with the accompanying drawings.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 illustrates a perspective view of a solar concentrator assembly of a solar electrical power generation system according to an exemplary embodiment of the invention.

FIG. 2 illustrates a schematic diagram showing a non-imaging dish concentrator, a plurality of secondary concentrators arranged to form an array, and a concentrator photovoltaic receiver according to a preferred embodiment of the present invention.

FIG. 3 illustrates a top view of the non-imaging dish concentrator consisting of a plurality of flat facet mirrors and the concentrator photovoltaic receiver located at the center according to a preferred embodiment of the present invention.

FIG. 4 illustrates a schematic diagram showing how the sunrays are focused by the non-imaging dish concentrator towards the array of secondary concentrators and then towards the concentrator photovoltaic receiver in the cross-sectional view.

FIG. 5 illustrate:

(a) The Cartesian coordinate system in 3-D representing a coordinate (Mₓ, M_{y}, M_{z}), incident angle (θᵢⱼ) and a pair of tilted angles (σ,γ) of a i,j-facet mirror where F is the focal distance of the NIDC and the origin ‘O’ is center of the concentrator frame. \vec{I} is unit vector of the incident sunray, \vec{N}_{i,j} is unit vector of the normal of i,j-facet mirror, \vec{R}_{i,j} is unit vector of the reflected solar ray of i,j-facet mirror.

(b) The initial facet mirror's configuration of the non-imaging dish concentrator. The concentrator can be divided into four quadrants which are the top-right, top-left, bottom-right and bottom-left.

FIG. 6 is a flow chart to illustrate a special computational method or algorithm or computer program operational steps describing on how to compute geometry of a plurality of flat facet mirrors for non-imaging dish concentrator (NIDC), which defines initial orientations of all facet mirrors arranged in an array at the same height first and then obtains final orientations of facet mirrors one by one from central to peripheral region of the NIDC with gradually increased height so that all the images can remain superimposition at the common receiver without sunlight blocking and shadowing among adjacent mirrors.

FIG. 7 illustrates the conceptual drawing on how to obtain final positions and orientations of flat facet mirrors in non-imaging dish concentrator using the special computational method or algorithm or computer program operational steps as described in FIG. 6 according to an embodiment of the present invention. In this process, we define initial orientations of all facet mirrors arranged in an array at the same height first and then obtains final orientations of facet mirrors one by one from central to peripheral region of the NIDC with gradually increased height so that all the images can remain superimposition at the common receiver without sunlight blocking and shadowing among adjacent mirrors: (a) Side view in y-z direction (b) Side view in x-z direction.

FIG. 8 illustrates an example of simulated solar flux distribution with maximum solar concentration ratio of 435 suns focused by the non-imaging dish concentrator at the entrance surface of the array of secondary concentrators according to a preferred embodiment of the present invention. The simulated result of solar flux distribution is performed using ray-tracing technique for the case of 22×22 array of facet mirrors with each facet dimension of 49.8 cm×49.8 cm and focal distance of 10 m.

FIG. 9 illustrates a schematic diagram showing a cross-sectional view of the arrangement of array of the crossed compound parabolic concentrators and concentrator photovoltaic receiver that consists of concentrator photovoltaic cells, concentrator photovoltaic cell substrates and heat sink.

FIG. 10 illustrates schematic diagrams showing (a) a trimetric view for an array of crossed compound parabolic concentrators. It is just an example of an array with 5×5 pieces secondary concentrators but the real design is not limited to this number; and (b) a trimetric view for one of the crossed compound parabolic concentrators.

FIG. 11 is a flow chart to illustrate a method of operating the dense-array concentrator photovoltaic system utilizing non-imaging dish concentrator, array of crossed compound parabolic concentrators and concentrator photovoltaic receiver as the solar electrical power generation system for optimizing solar power generation efficiency.

### DETAILED DESCRIPTION OF THE PREFERRED EMBODIMENTS

The present invention will now be described in detail with reference to the accompanying drawings. However, the description or the illustrations as disclosed herein should not be construed as the limitation of said invention.

The present invention relates to the field of solar electrical power generation system. More particularly, the present invention relates to a NIDC integrated with an array of crossed compound parabolic concentrators in the application of concentrator photovoltaic (CPV) system. The present invention is an improved and efficient solar concentrator assembly (100) of a solar electrical power generation system. The solar concentrator assembly (100) comprises at least one array of facet mirrors (160) arranged to form at least one primary concentrator (110), at least one concentrator photovoltaic receiver (170) and at least one array of secondary concentrators (120) for directing solar energy to the at least one concentrator photovoltaic receiver (170). A non-imaging dish concentrator (NIDC) is employed as the at least one primary concentrator (110). A plurality of crossed compound parabolic concentrators that is arranged in an array forms the array of secondary concentrators (120).

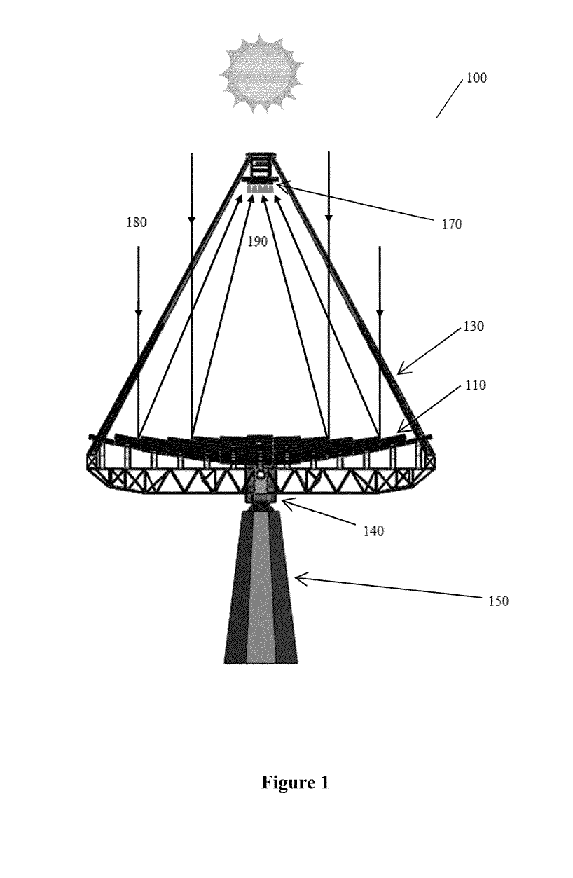

FIG. 1 illustrates a perspective view of a solar concentrator assembly (100) acting as a solar electrical power generation system according to a preferred embodiment of the invention. The NIDC (110) includes a plurality of flat facet mirrors arranged to form a large array to collect the sunlight incident over a large area. The NIDC (110) is supported on a truss member assembly. The truss member assembly forms a part of a structural supporting means (130) which provides mechanical support to the solar concentrator assembly (100). The truss member assembly is attached to at least one pedestal (150). The at least one pedestal (150) supports the entire solar concentrator assembly (100). The at least one NIDC (110) acts as the primary concentrator for reflecting the incident solar energy towards the at least one array of secondary concentrators (120) and then towards at least one concentrator photovoltaic receiver (170). The truss member assembly with the NIDC (110) is attached to the at least one pedestal (150) with the help of at least one gearbox (140). The at least one gearbox (140) is preferably fixed on the at least one pedestal (150). The truss member assembly with the NIDC (110) can be tilted by the rotational movement of the at least one gearbox (140). For effectively improving the efficiency in collecting the incident sunlight during daytime, the NIDC (110) is tilted by operating the at least one gearbox (140). The at least one gearbox (140) is operated to orient the NIDC (110) towards the direction of maximum sunlight during daytime for receiving maximum sunlight onto the NIDC (110).

The NIDC (110) includes a plurality of flat facet mirrors arranged to form an array. The plurality of flat facet mirrors are arranged to form an arc-shaped NIDC (110), in which the peripheral flat facet mirrors are positioned at a higher level than the centrally located flat facet mirrors. This type of configuration allows for avoiding sunlight blocking and shadowing among adjacent mirrors. The arc-shaped NIDC (110) is attached to the at least one gearbox (140) utilizing at least one rotational axial joint means. The concentrator photovoltaic receiver (170) and the array of secondary concentrators (120) are positioned at a predetermined height depending on the size and shape of the arc-shaped NIDC (110). The array of secondary concentrators (120) includes an array of crossed compound parabolic concentrators (120) positioned below the concentrator photovoltaic receiver (170). The array of crossed compound parabolic concentrators (120) and the concentrator photovoltaic receiver (170) are held in position with the help of at least one structural support means (130). The sunrays are incident (180) on the NIDC (110), which concentrates the solar energy and a plurality of reflected rays (190) are focused to the array of secondary concentrators (120) or secondary optics and subsequently to the concentrator photovoltaic receiver (170). Thus the amount of incident solar energy per unit area can be increased by using the primary concentrator (110) and the array of secondary concentrators (120). Thereby each CPV cell of the concentrator photovoltaic receiver (170) generates more electrical energy via converting incident solar energy to electrical energy. The arrangement of the primary concentrator such as the NIDC (110) allows for more efficient generation of electricity by eliminating sunlight blocking and shadowing effects as well as by minimizing the gap between adjacent facets.

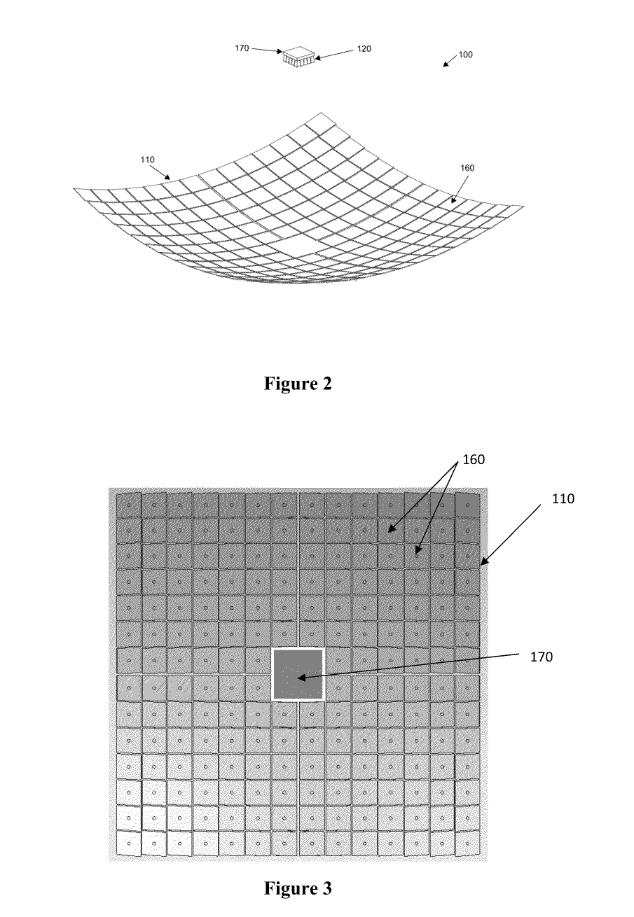

FIG. 2 illustrates a schematic diagram showing the NIDC (110) comprising the plurality of flat facet mirrors (160) arranged to form an array according to a preferred embodiment of the present invention. The NIDC (110) includes a plurality of flat facet mirrors (160) arranged into any form of array. However, FIG. 2 illustrates an exemplary illustration of one possible arrangement of the array of a plurality of flat facet mirrors (160). Embodiments of the invention include the plurality of flat facet mirrors (160) arranged to form arrays of different shapes and sizes to build the NIDC (110). Each flat facet mirror (160) is tilted at certain angle in such a way that all the solar images formed by the plurality of flat facet mirrors (160) forming the array are superimposed at a destined target, i.e. the entrance surface of array of secondary concentrators (120). The height of flat facet mirrors (160) are gradually increased from central to peripheral position of the NIDC (110) to avoid sunlight blocking and shadowing among adjacent mirrors. Above the NIDC (110), there are an array of crossed compound parabolic concentrators (120) and concentrator photovoltaic receiver (170). The crossed compound parabolic concentrators (120) are arranged in 2-D array in such a way that the array dimension is almost same as that of focused solar images formed by NIDC (110). The plurality of flat facet mirrors (160) positioned at the central region of the NIDC (110) is removed so that there is no shadowing from the concentrator photovoltaic receiver (170) and the array of secondary concentrators (120) cast on any of the facet mirrors. The concentrator photovoltaic receiver (170) and the array of secondary concentrators (120) are positioned at a predetermined height depending on the size and shape of the arc-shaped NIDC (110). The detailed description of the array of crossed compound parabolic concentrators (120) is presented in FIGS. 9 and 10.

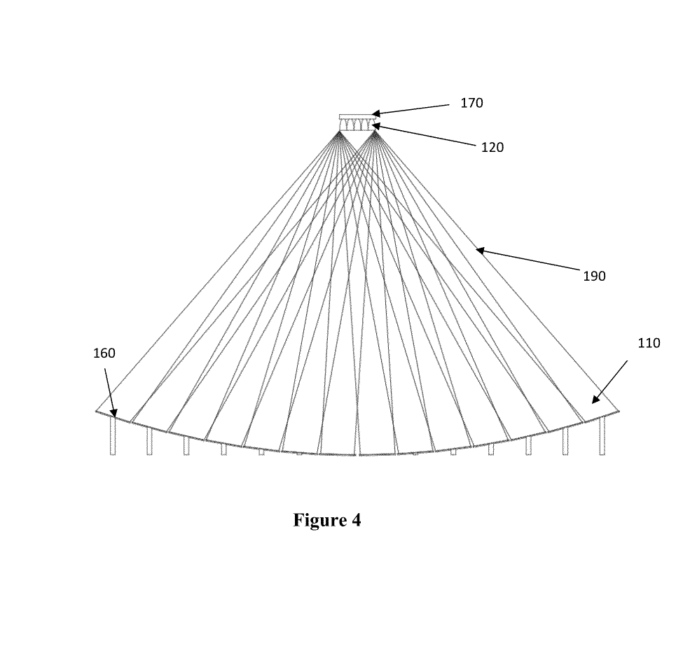

FIG. 3 illustrates a top view of the NIDC (110) according to a preferred embodiment of the present invention. The NIDC (110) does not follow any specific geometry. The NIDC (110) follows a computer generated geometry based on a specially designed computational method or algorithm or computer program operational steps as described in the following FIG. 6. The NIDC (110) employs many identical square or rectangular facet mirrors (160) acting as optical aperture to gather the solar irradiance from the sun and to superimpose all the solar images at entrance surface of the array of secondary concentrators (120). In a preferred embodiment of the invention, the NIDC (110) consists of 2m×2n array of the plurality of identical flat facet mirrors (160) arranged at different height to eliminate sunlight blocking and shadowing effects as well as to minimize the gap between the adjacent facets. The concentrator photovoltaic receiver (170) and the array of secondary concentrators (120) are arranged at an elevated position above the NIDC (110). When sunlight falls on this arrangement a shadowing effect is produced and the plurality of flat facet mirrors (160) which are affected by the shadowing caused by the concentrator photovoltaic receiver (170) and the array of secondary concentrators (120) are removed. In addition, embodiments of the present invention, the NIDC (110), can also have a higher or lower solar concentration ratio by simply increasing or decreasing the total number of flat facet mirrors (160).

FIG. 4 illustrates a schematic diagram showing how the reflected sunrays (190) are focused by the NIDC (110) onto the entrance surface of the secondary concentrator (120) and subsequently reaching the concentrator photovoltaic receiver (170) in the cross-sectional view. The plurality of flat facet mirrors (160) is packed together with minimum amount of gap between the adjacent mirrors. The heights of flat facet mirrors (160) are increased gradually from central to peripheral position of the NIDC (110) using suitable mechanical means. The purpose of plurality of flat facet mirrors (160) positioned at different levels is to effectively avoid sunlight blocking and shadowing among adjacent flat facet mirrors (160). Hence this arrangement of flat facet mirrors (160) can maximize the amount of effective sunlight falling on the facet mirrors (160) and reflecting to entrance surface of the array of secondary concentrators (120). The NIDC (110) formed by the array of plurality of flat facet mirrors (160) superimposes the solar images formed by individual facet mirrors (160) onto entrance surface of the array of the crossed compound parabolic concentrators (120) i.e. the secondary concentrators (120). The arc-shaped of the NIDC (110) formed by the array of the plurality of flat facet mirrors (160) arranged at different height helps in superimposing the solar images formed by individual facet mirrors (160) onto entrance surface of the secondary concentrators (120) and thereafter to the concentrator photovoltaic receiver (170). The light concentrated by the primary concentrator (110) is further concentrated by the array of secondary concentrators (120) before reaching the concentrator photovoltaic receiver (170).

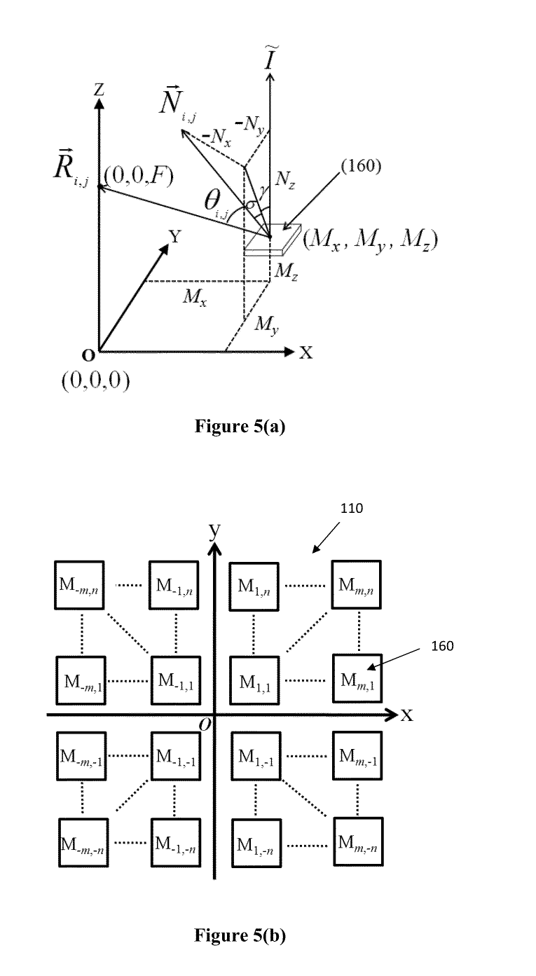

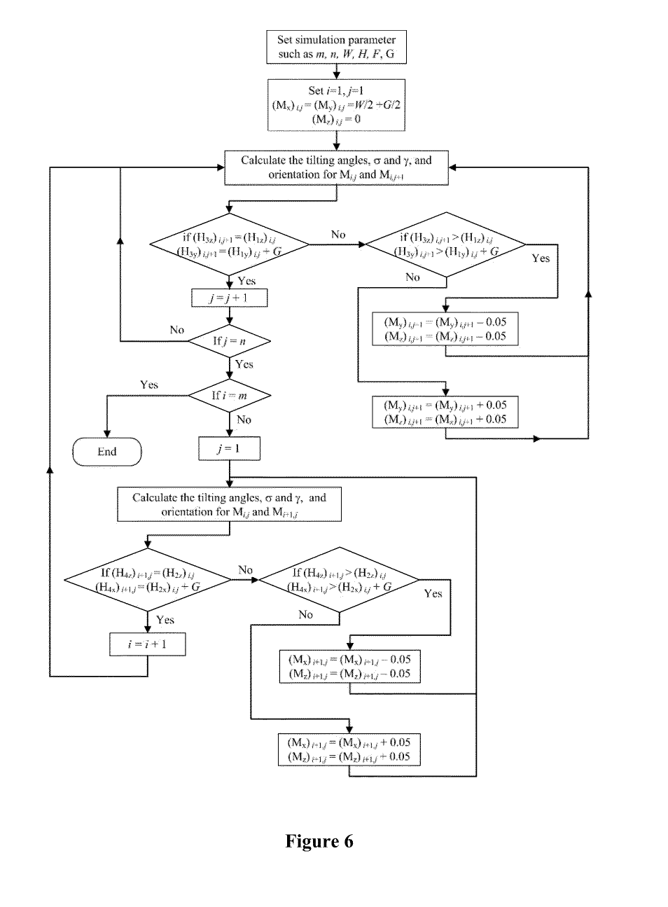

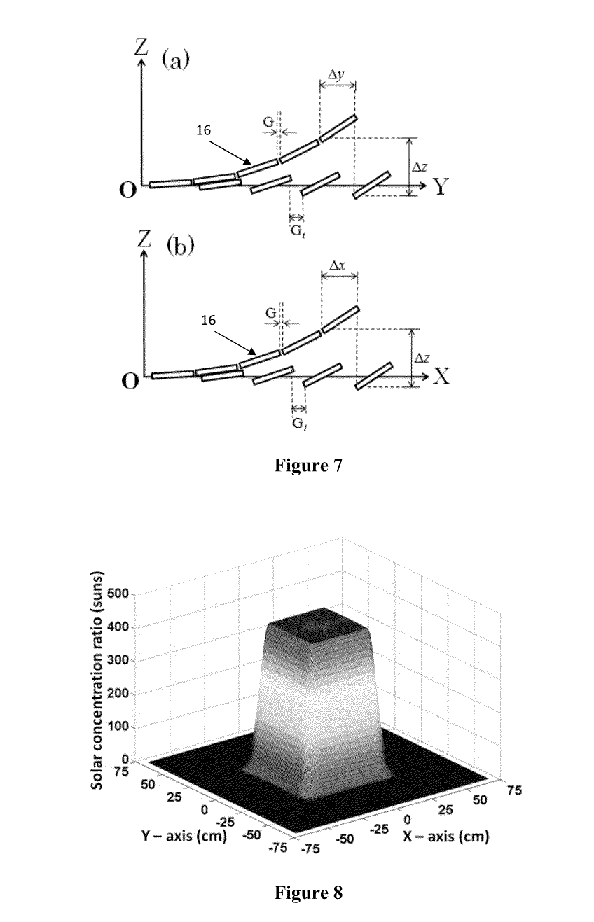

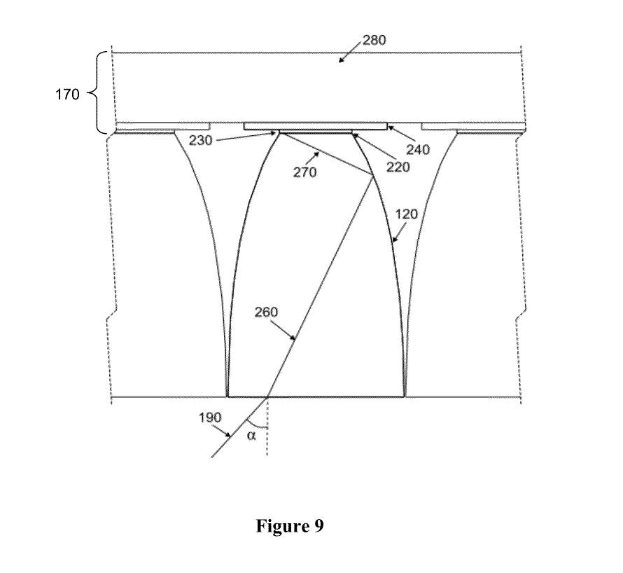

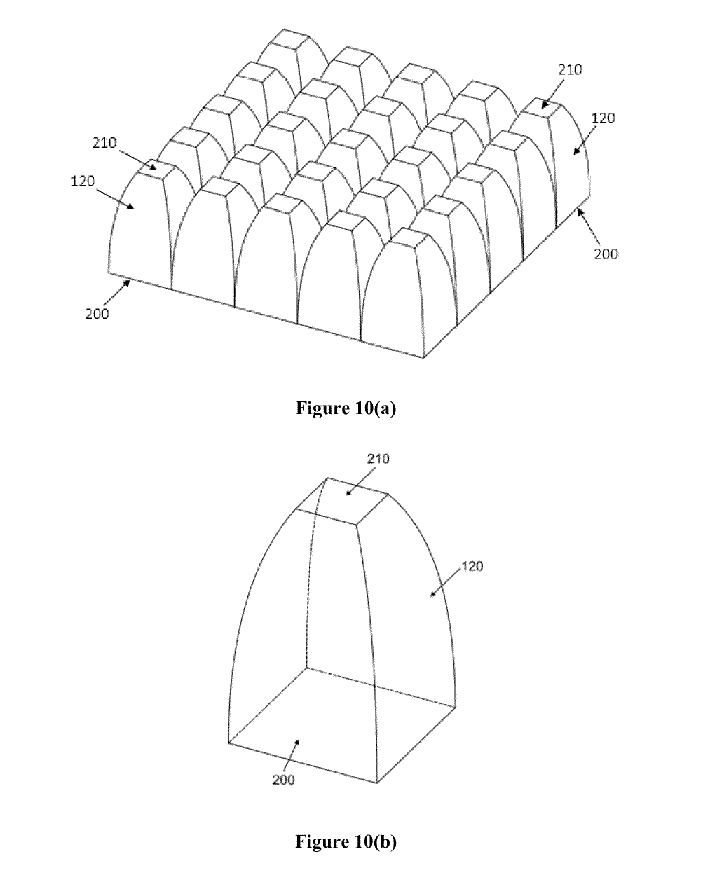

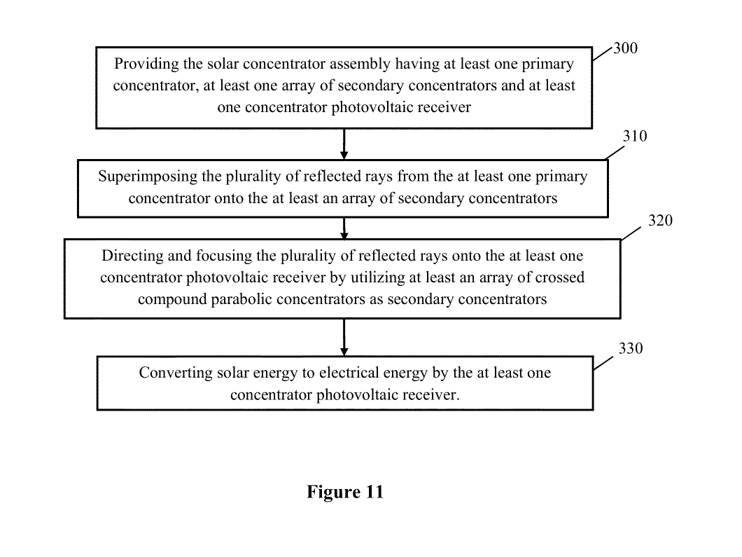

FIG. 5(a) illustrates the Cartesian coordinate system in 3-D representing a coordinate (Mₓ, M_{y}, M_{z}), incident angle (θᵢⱼ) and a pair of tilted angles (σ,γ) of a i,j-facet mirror (160) where F is the focal distance of the NIDC (110) and the origin ‘O’ is center of the concentrator frame. The locality of each facet mirror (160) on the NIDC (110) can be indexed as (i, j), where i and j represent the position of the facet mirror (160) at i-th row and j-th column of the NIDC (110) respectively. \vec{I} is unit vector of the incident sunray (180), \vec{N}_{i,j} is unit vector of the normal of i,j-facet mirror (160), \vec{R}_{i,j} is unit vector of the reflected sunray (190) of i,j-facet mirror. The NIDC (110) employs the plurality of identical square or rectangular flat facet mirrors (160) acting as optical aperture to gather the solar irradiance from the sun and to superimpose all the images at the receiver. The NIDC (110) consists of 2m×2n array of identical flat facet mirrors (160) arranged at different height to eliminate sunlight blocking and shadowing effects as well as to minimize the gap between the adjacent facets. In FIG. 5(a), the central line of the NIDC (110) starting from the origin denoted as ‘O’ and lies along the row direction is defined as x-axis. The central line of the NIDC (110) from the origin ‘O’ lies along the column direction is defined as y-axis. Lastly, z-axis is defined from the origin ‘O’ pointing to the target direction that is also perpendicular to both the x-axis and y-axis. The flat facet mirrors (160) in the NIDC (110) are fixed at two tilted angles to superimpose the plurality of sunrays (180) incident on the NIDC (110) onto the array of secondary concentrators (120) and then to the concentrator photovoltaic receiver (170) associated with the solar concentrator assembly (100). The two tilted angles of i,j-facet mirror are represented by, σ is a tilted angle about y-axis, and γ is a tilted angle about x-axis. The angles can be expressed as

$$σ = {sin}^{- 1} ( \frac{{M}_{x}}{2 cos {θ}_{i , j} \sqrt{{M}_{x}^{2} + {M}_{y}^{2} + {( F - {M}_{z} )}^{2}}} )$$

$$γ = {tan}^{- 1} ( \frac{{M}_{y}}{( F - {M}_{z} ) + \sqrt{{M}_{x}^{2} + {M}_{y}^{2} + {( F - {M}_{z} )}^{2}}} )$$

where Mₓ, M_{y}, M_{z} are the global coordinate of the central point of i,j-facet mirror (160) in x-axis, y-axis, z-axis respectively, F is the distance between the center of entrance aperture of the array of secondary concentrators (120) and the origin ‘O’ that is the center of the concentrator frame, which is also known as the focal distance of NIDC (110). The incident angle θ_{i,j} of the sunrays (180) can be expressed as

$${θ}_{i , j} = [ \frac{1}{2} {tan}^{- 1} ( \frac{\sqrt{{M}_{x}^{2} + {M}_{y}^{2}}}{F - {M}_{z}} ) ]$$

To achieve perfect optical efficiency for transferring the entire reflected rays (190) from the facet mirrors (160) to the entrance surface of the array of secondary concentrators (120), the sunlight blocking and shadowing effects among adjacent facet mirrors (160) need to be eliminated. This is done according to a preferred embodiment of the present invention by designing the plurality of facet mirrors (160) with gradually increased height along z-direction from the center to the edge of primary concentrator (110). Moreover, gaps between the facet mirrors (160), G, are also minimized to optimize the total collective area of the primary concentrator or the NIDC (110). The locations of facet mirrors (160) are computed in both directions along x and y axes to minimize the gap among the facet mirrors (160) at a certain distance. FIG. 5(b) shows the initial facet mirror's configuration of the non-imaging dish concentrator (110). The concentrator can be divided into four quadrants which are the top-right, top-left, bottom-right and bottom-left.

FIG. 6 is a flow chart to illustrate how the special computational method or algorithm or computer program operational steps can compute the geometry of the plurality of flat facet mirrors (160) in designing the new arc-shaped geometry of NIDC (110). According to FIG. 5(b), all facet mirrors in the NIDC (110) can be sub-divided into four major quadrants and the origin ‘O’ is located at the center of the NIDC (110). Since the geometrical configuration of facet mirrors (160) in the four quadrants is symmetry to each other, the computational algorithm only needs to consider any of the four quadrants in the process of designing the geometry of primary concentrator i.e. the NIDC (110) to save the computational time. Therefore, the top-right quadrant of the primary concentrator (110) is chosen as a reference for computing the geometry of the NIDC (110). Referring to FIG. 5(b), the facet mirror (160) located closest to the origin is defined as M_{1,1} and the facet mirror (160) located furthest from the origin is defined as M_{m,n}, provided that m is the number of column and n is the number of row in the top-right quadrant of the NIDC (110). For a convenience of the computational method or algorithm or computer program operational steps in designing the geometry of the NIDC (110), a plurality of flat facet mirrors (160) is first assumed to be arranged in an array form, where the pivot points for all the facet mirrors (160) are defined in the same horizontal plane or in the same height and the orientations of all facet mirrors (160) are aligned for superimposing solar images onto the target. In such an arrangement, sunlight blocking and shadowing among adjacent facet mirrors (160) are more serious for the facet mirrors (160) located further from the central region. Then, according to the computational method or algorithm or computer program operational steps, each of the facet mirrors (160) is virtually lifted up one by one from the central toward the peripheral region of concentrator frame along the x, y, and z directions in order to eliminate the sunlight blocking and shadowing effects while keeping fixed gaps among the facet mirrors (160). The final positions of the facet mirrors (160) that form a dish will be different from that of the initially defined position in the horizontal plane and the process to determine new mirror positions will cause the variation in the tilted angles of the facet mirrors (160) as to maintain the solar images aiming at the target or the array of secondary concentrators (160). Hence, in the process of designing the new geometry of the NIDC (110), an iterative method is used to calculate the final position as well as the two tilted angles, σ and γ, of each facet mirror (160).

FIG. 7 shows (a) Side view in y-z direction (b) Side view in x-z direction to illustrate the conceptual drawing on how to compute the position of each flat facet mirror (160) and to design the arc-shaped geometry of the non-imaging dish concentrator (110) using a special computational method or algorithm or computer program operational steps. The computational algorithm starts with defining the initial positions of all facet mirrors (160) at the same height and then obtains final positions of facet mirrors (160) one by one from the central region towards the peripheral region with gradually increased height as to eliminate sunlight blocking and shadowing among adjacent mirrors (160) as well as to minimize the gap between adjacent mirrors (160) according to an embodiment of the present invention. This computational algorithm will start to compute final positions of the facet mirrors (160) located at the first column, i=1 with row sequence starting from j=1 to j=n. The same procedure is also continued for the following column from i=2 to i=m. The detail of method or algorithm or computer program operational steps to compute the configuration of the facet mirrors (160) in the NIDC (110) is summarized in the flow chart as shown in FIG. 6. Let Gᵢ is initial gap between the facet mirrors (160) and G is the final gap between the facet mirrors (160) obtained from the special computational algorithm.

FIG. 8 shows the numerical simulation result of solar flux distribution with maximum solar concentration ratio of 435 suns for the case of 22×22 array of facet mirrors (160) with each facet dimension of 49.8 cm×49.8 cm and focal distance of 10 m in 3D plot. It is an example of simulated solar flux distribution plot focused by the NIDC (110) on entrance surface of array of secondary concentrators (120) using ray-tracing technique according to a preferred embodiment of the present invention. From the FIG. 8, it is clear that each facet mirror (160) reflects the incident solar irradiance towards the array of secondary concentrators (120) and then to the photovoltaic receiver (170).

FIG. 9 illustrates a schematic diagram showing a cross-sectional view of the arrangement of the array of secondary concentrators (120) and the concentrator photovoltaic receiver (170). The concentrator photovoltaic receiver (170) consists of concentrator photovoltaic cells (230), concentrator photovoltaic cell substrates (240) and the heat sink (280). The secondary concentrator (120) is a crossed compound parabolic concentrator (120) that is preferably a solid body made from transparent material with high refractive index such as silica in order to increase the acceptance angle of the secondary concentrator (120). An array of crossed compound parabolic concentrators (120) is proposed as the secondary concentrators (120) or lenses due to the geometry allowing high acceptance angle in which the plurality of reflected rays (190) may encounter total internal reflection after transmitting into the crossed compound parabolic concentrators (120) before absorbed by the concentrator photovoltaic cell (230). FIG. 9 also shows a functional side view of the crossed compound parabolic concentrators (120) with three exemplary light rays namely 190, 260, and 270, respectively going through three continuous optical phenomena including refraction at the entrance, total internal reflection at the lens interface and absorption by the concentrator photovoltaic cell (230). The concentrator photovoltaic cell (230) is bonded to a heat conductive substrate (240). A clear encapsulant (220) is employed to optically couple between the exit face (210) of the crossed compound parabolic concentrator (120) and the concentrator photovoltaic cell (230).

‘α’ is defined as the maximum incident angle relative to the normal of entrance surface of crossed compound parabolic concentrator (120) in which the incident ray can still be directed to the exit surface of crossed compound parabolic concentrator (120). Here ‘2α’ is the maximum acceptance angle of the crossed compound parabolic concentrator (120). The maximum acceptance angle, ‘2α’, must be at least four times of the largest incident angle, ‘4θ_{i,j}’, among all the flat facet mirrors (160) of the NIDC (110).

The entrance surface of plurality of second stage or secondary concentrators (120) is placed at the focal plane of first stage or primary concentrator (110) in such a way that the plurality of second stage concentrators (120) further focuses the sunlight concentrated by first stage concentrator (110) onto the active area of the solar cell or the concentrator photovoltaic cell (230). The solar cell (230) converts the incident solar energy into electrical energy. As the amount of incident solar radiation on the solar cell (230) is increased the electric power generated is also increased.

FIG. 10 illustrates a schematic diagram showing (a) a trimetric view for an array of crossed compound parabolic concentrators (120). It is just an example of an array with 5×5 pieces secondary concentrators (120) but the real design is not limited to this number; and (b) a trimetric view for one of crossed compound parabolic concentrators (120). Each crossed compound parabolic concentrator (120) consists of two symmetrical compound parabolic concentrator troughs that intersect orthogonally. In various embodiments, the entrance face (200) and exit face (210) of the crossed compound parabolic concentrator (120) can be either rectangular or square in shape dependent on both the dimension of the solar cell (230) and the distance between adjacent solar cells (230). The largest tilted angle of the flat facet mirror (160) of the NIDC (110) will determine the acceptance angle of the crossed compound parabolic concentrator (120). The area and size of the exit face (210) of the crossed compound parabolic concentrator (120) is determined in such a manner to match with the size of the concentrator photovoltaic cell (230) of the concentrator photovoltaic receiver (170).

FIG. 11 is a flow chart to illustrate a method of operating the solar concentrator assembly (100) of the solar electrical power generation system for optimizing efficiency of solar power generation. The method comprises the steps of providing the solar concentrator assembly (100) having at least one primary concentrator (110), at least one array of secondary concentrators (120) and at least one concentrator photovoltaic receiver (170) as shown in block 300. The whole solar concentrator assembly (100) is tilted using at least one gear assembly (140) to collect maximum amount of sunlight. Then the incident sunlight on the plurality of flat facet mirrors (160) of the primary concentrator (110) is reflected towards the destined target. Now as indicated in block 310, a plurality of reflected rays (190) from the at least one primary concentrator (110) are superimposed and thereafter directed and focused onto the at least one concentrator photovoltaic receiver (170) via at least one array of crossed compound parabolic concentrators (120) acting as secondary concentrators (120) as shown in block 320. Finally, as in block 330, the solar energy is converted to electrical energy by the at least one concentrator photovoltaic receiver (170).

The at least one primary concentrator (110) of the solar concentrator assembly (100) is non-imaging dish concentrator (110) which comprises of a plurality of flat facet mirrors (160). The plurality of flat facet mirrors (160) are arranged for superimposing plurality of mirror images onto entrance surface of the at least one array of secondary concentrators (120). Each plurality of flat facet mirrors (160) is arranged at a plurality of levels from central region to peripheral region of the NIDC (110) for effectively superimposing the plurality of mirror images onto entrance surface of the array of secondary concentrators (120) without sunlight blocking and shadowing on each other. The at least one array of secondary concentrators (120) comprises of a plurality of crossed compound parabolic concentrators (120) arranged to form a 2D array to match with the size and shape of concentrated solar irradiance formed by the NIDC (110). The plurality of crossed compound parabolic concentrators (120) forms a plurality of optical funnels having larger area on the entrance surface and smaller area on the exit surface. The larger area on the entrance surface and smaller area on the exit surface allows more spacing among the solar cells (230) located at the exit surface for optimal inter-connection of a plurality of solar cells (230) in series and/or in parallel forming the concentrator photovoltaic receiver (170). The plurality of crossed compound parabolic concentrators (120) efficiently concentrates the solar energy to an active areas of array of solar cells (230) in a manner of one crossed compound parabolic concentrator (120) coupled to one solar cell (230). In addition, the at least one array of secondary concentrators (120) increases an acceptance angle thereby allowing a higher tolerance to pointing error of sun-tracking of the solar concentrator assembly (100). The arc-shaped geometry of the non-imaging dish concentrator (110) is designed by using the computational method or algorithm or computer program operational steps as described in FIG. 6 so that it is capable of projecting a reasonably uniform and rectangular pattern of concentrated sunlight onto entrance surface of the array of secondary concentrators (120). This result in an optimal and efficient generation of electrical energy compared to the existing solar power generation systems.

The preferred commercial applications of the solar concentrator assembly (100) according to embodiments of the present invention includes use in solar power plant in large scale where multiple units of the solar concentrator assembly (100) are arranged and operated in parallel for generating large amount of electrical power. In addition, the solar concentrator assembly (100) is employed in building retrofit system for producing electrical power and hot water for domestic usage. For the above application, the solar concentrator assembly (100) can be used as grid-connected concentrator photovoltaic system. For off-grid application, solar concentrator assembly (100) can also be used as an isolated power generation system for telecommunication tower, street lighting, light house for navigation, etc. Another principal application of the solar concentrator assembly (100) is the use in power generation station in rural area, which is usually far from power grid.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification. However, all such modifications are deemed to be within the scope of the claims.

1. A solar concentrator assembly (100) of a solar electrical power generation system comprises:
at least one primary concentrator (110) arranged to receive and reflect a plurality of sunrays (180), the at least one primary concentrator (110) being a non-imaging dish concentrator (NIDC) (110) attached to the at least one pedestal (150) with the help of at least one gearbox (140);
at least one concentrator photovoltaic receiver (170) associated with the solar concentrator assembly (100) for converting solar energy to electrical energy;
at least one array of secondary concentrators (120) for focusing and thereafter directing solar energy to the at least one concentrator photovoltaic receiver (170); and
at least one structural support means (130) for supporting the array of secondary concentrators (120) and the concentrator photovoltaic receiver (170).

2. The solar concentrator assembly (100) as claimed in claim 1 wherein the non-imaging dish concentrator (110) includes a plurality of flat facet mirrors (160), and the plurality of flat facet mirrors (160) is capable of being arranged into a plurality of forms to create at least one array.

3. The solar concentrator assembly (100) as claimed in claim 1 wherein the plurality of flat facet mirrors (160) is capable of being tilted at an angle to gather solar irradiance from the sun and thereafter superimposing a plurality of solar images formed by the flat facet mirrors (160) at a predefined target to produce reasonably uniform solar irradiance, the predefined target being the entrance surface of the array of secondary concentrators (120).

4. The solar concentrator assembly (100) as claimed in claim 1 wherein a new non-imaging geometry of the NIDC (110) is based on a computer generated geometry determined using at least one method created by a special computational method.

5. The solar concentrator assembly (100) as claimed in claim 1 wherein the plurality of flat facet mirrors (160) of the NIDC (110) is arranged at a plurality of levels for minimizing gap between adjacent flat facet mirrors (160).

6. The solar concentrator assembly (100) as claimed in claim 1 wherein the plurality of flat facet mirrors (160) of the NIDC (110) is arranged at a plurality of levels for eliminating sunlight blocking and shadowing effects among adjacent flat facet mirrors (160).

7. The solar concentrator assembly (100) as claimed in claim 1 wherein the non-imaging dish concentrator (110) is supported on the at least one pedestal structure (150), the at least one pedestal structure (150) supports a weight of the solar concentrator assembly (100).

8. The solar concentrator assembly (100) as claimed in claim 1 wherein the non-imaging dish concentrator (110) can be tilted by rotational movement towards the plurality of sunrays (180) with maximum intensity by employing the at least one gearbox (140) coupled with the non-imaging dish concentrator (110), the at least one gearbox (140) is supported on the at least one pedestal structure (150).

9. The solar concentrator assembly (100) as claimed in claim 1 wherein the at least one non-imaging dish concentrator (110) concentrates the plurality of sunrays (180) by directing a plurality of reflected rays (190) towards the at least one array of secondary concentrators (120) and then subsequently towards the at least one concentrator photovoltaic receiver (170).

10. The solar concentrator assembly (100) as claimed in claim 9 wherein the at least one array of secondary concentrators (120) includes an array of crossed compound parabolic concentrators (120) acting as lenses with high acceptance angle, each crossed compound parabolic concentrator (120) is a solid body made of transparent material such as silica; wherein the plurality of reflected rays (190) may encounter total internal reflection after transmitting into the crossed compound parabolic concentrators (120).

11. The solar concentrator assembly (100) as claimed in claim 10 wherein the at least one array of crossed compound parabolic concentrators (120) acting as secondary concentrators (120) guide the plurality of sunrays (180) onto active areas of solar cells (230) of the at least one concentrator photovoltaic receiver (170).

12. The solar concentrator assembly (100) as claimed in claim 1 wherein the at least one array of secondary concentrators (120) directs the plurality of reflected rays (190) to the at least one concentrator photovoltaic receiver (170) for transforming solar energy to electrical energy.

13. The solar concentrator assembly (100) as claimed in claim 1 wherein the at least one non-imaging dish concentrator (110) is held in position with the at least one concentrator photovoltaic receiver (170) and at least one array of secondary concentrators (120) by employing the at least one of structural support means (130).

14. A method of converting solar energy into electrical energy utilizing a solar concentrator assembly (100) of a solar electrical power generation system, the method comprising the steps of:
providing the solar concentrator assembly (100) having at least one primary concentrator (110), at least one array of secondary concentrators (120) and at least one concentrator photovoltaic receiver (170);
receiving a plurality of sunrays (180) incident on at least one array of a plurality of flat facet mirrors (160) forming the at least one primary concentrator (110);
superimposing the plurality of reflected rays (190) from the at least one primary concentrator (110) onto the at least one array of secondary concentrators (120);
directing and focusing the plurality of reflected rays (190) onto the at least one concentrator photovoltaic receiver (170) by utilizing at least one array of crossed compound parabolic concentrators (120) as secondary concentrators (120); and
converting solar energy to electrical energy by the at least one concentrator photovoltaic receiver (170).

15. The method of converting solar energy into electrical energy as claimed in claim 14 wherein the at least one primary concentrator (110) is a non-imaging dish concentrator (110).

16. The method of converting solar energy into electrical energy as claimed in claim 14 wherein the at least one non-imaging dish concentrator (110) comprises plurality of flat facet mirrors (160), the plurality of flat facet mirrors (160) being arranged for superimposing plurality of mirror images at entrance surface of the at least one array of secondary concentrators (120) without sunlight blocking and shadowing on each other.

17. The method of converting solar energy into electrical energy as claimed in claim 16 wherein the plurality of flat facet mirrors (160) being arranged at a plurality of levels from central position of the non-imaging dish concentrator (110) to peripheral position for effectively superimposing the plurality of mirror images on entrance surface of the array of secondary concentrators (120) without sunlight blocking and shadowing among adjacent facet mirrors.

18. The method of converting solar energy into electrical energy as claimed in claim 14 wherein the at least one array of secondary concentrators (120) comprises a plurality of crossed compound parabolic concentrators (120) arranged to form at least one array.

19. The method of converting solar energy into electrical energy as claimed in claim 18 wherein the plurality of crossed compound parabolic concentrators (120) forms a plurality of optical funnel having a larger area on an entrance surface and a smaller area on an exit surface.

20. The method of converting solar energy into electrical energy as claimed in claim 18 wherein the plurality of crossed compound parabolic concentrators (120) having the larger area on the entrance surface and the smaller area on the exit surface allows more spacing for optimal inter-connection of a plurality of solar cells (230) of the concentrator photovoltaic receiver (170) located at the exit surface in series and/or in parallel for minimizing current mismatch loss.

21. The method of converting solar energy into electrical energy as claimed in claim 18 wherein the plurality of crossed compound parabolic concentrators (120) having the larger area on the entrance surface and the smaller area on the exit surface allows a plurality of solar cells (230) of the concentrator photovoltaic receiver (170) receiving higher intensity of solar irradiance with the ratio dependent on the entrance surface area to exit surface area.

22. The method of converting solar energy into electrical energy as claimed in claim 18 wherein each of the plurality of crossed compound parabolic concentrators (120) efficiently concentrates the solar energy to an active area of each solar cell (230) in the concentrator photovoltaic receiver (170).

23. The method of converting solar energy into electrical energy as claimed in claim 14 wherein the at least one array of secondary concentrators (120) increases an acceptance angle thereby allowing a higher tolerance to pointing error of sun-tracking of the solar concentrator assembly (100).

24. The method of converting solar energy into electrical energy as claimed in claim 14 wherein the at least one non-imaging dish concentrator (110) is capable of projecting reasonably uniform irradiance and either square or rectangular pattern of concentrated sunlight onto entrance surface of the at least one array of secondary concentrators (120).
